(19) United States
(12) Patent Application Publication
(10) Pub. No.: US 2025/0193118 A1
(43) Pub. Date: Jun. 12, 2025

(54) CONGESTION CONTROL IN WIRELESS NETWORKS

(71) Applicant: Samsung Electronics Co., Ltd., Suwon-si (KR)

(72) Inventors: Kyeong Jin Kim, Plano, TX (US); Abhishek Sehgal, Frisco, TX (US); Yuming Zhu, Plano, TX (US); Neha Dawar, Mckinney, TX (US)

(21) Appl. No.: 18/967,545

(22) Filed: Dec. 3, 2024

Related U.S. Application Data
(60) Provisional application No. 63/609,161, filed on Dec. 12, 2023.

(51) Int. Cl. H04L 47/127; H04W 56/00

(52) U.S. Cl. CPC H04L 47/127; H04W 56/0055

(57) ABSTRACT

A destination station (STA) in a wireless network, comprising: a memory; and a processor coupled to the memory, the processor configured to: receive, from a source STA via a router, a plurality of packets, the router being located between the destination STA and a source STA; determine a congestion prediction to the source STA based on packet arrival times of the plurality of packets; compare the congestion prediction with a first threshold; generate a congestion prediction signal based on the comparison, wherein the congestion prediction signal indicates an operation mode of the source STA; and transmit, to the source STA via the router, the congestion prediction signal.

### CROSS-REFERENCE TO RELATED APPLICATION(S)

This application claims the benefit of priority from U.S. Provisional Application No. 63/609,161, entitled “LINK ADAPTATION BASED ON CONGESTION PREDICTION,” filed Dec. 12, 2023, which is incorporated herein by reference in its entirety.

### TECHNICAL FIELD

This disclosure relates generally to a wireless communication system, and more particularly to, for example, but not limited to, congestion control in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a destination station (STA) in a wireless network, comprising a memory; and a processor coupled to the memory. The processor is configured to: receive, from a source STA via a router, a plurality of packets, the router being located between the destination STA and a source STA. The processor is configured to determine a congestion prediction to the source STA based on packet arrival times of the plurality of packets. The processor is configured to compare the congestion prediction with a first threshold. The processor is configured to generate a congestion prediction signal based on the comparison, wherein the congestion prediction signal indicates an operation mode of the source STA. The processor is configured to transmit, to the source STA via the router, the congestion prediction signal.

In some embodiments, the packet arrival times are associated with delay in a buffer at the router or propagation delay between the destination STA and the source STA.

In some embodiments the processor is further configured to, during a first time window: determine that the congestion prediction is less than the first threshold; and generate the congestion prediction signal indicating a first operation mode that the source STA operates in a single link operation mode using a primary link or that the source STA maintains a packet transmission rate from source STA to the destination STA.

In some embodiments the processor is further configured to, during a second time window: determine that the congestion prediction is greater than the first threshold; and generate the congestion prediction signal indicating a second operation mode that the source STA operates in a multi-link operation mode using the primary link and one or more secondary links or that the source STA decreases the packet transmission rate from the source STA to the destination STA.

In some embodiments, the processor is further configured to, during a third time window: determine that the congestion prediction is less than a second threshold, wherein the second threshold is less than the first threshold; and generate the congestion predication signal indicating that the source STA returns to operating in the first operation mode.

In some embodiments, the processor is further configured to estimate a set of autoregressive coefficients that models congestion from the packet arrival packet times.

In some embodiments, the processor is further configured to perform training on samples within a training interval to estimate the set of autoregressive coefficients.

In some embodiments the processor is further configured: receive, from the router, a congestion notification signal indicating congestion at the router; and perform a logical operation based on the received congestion notification signal and the congestion prediction signal to generate the congestion prediction signal.

One aspect of the present disclosure provides a source station (STA) in a wireless network, comprising: a memory and a processor coupled to the memory. The processor is configured to receive, from a destination STA via a router, a congestion predication signal that indicates an operation mode for the source STA, the router being located between the source STA and the destination STA. The processor is configured to transmit packets to the destination STA based on the operation mode indicated by the congestion predication signal.

In some embodiments, the processor is further configured to, during a first time window: operate in a first operation mode such that the source STA operates in a single link operation mode using a primary link or that the source STA maintains a packet transmission rate from source STA to the destination STA based on the congestion prediction signal indicating the first operation mode.

In some embodiments, the processor is further configured to, during a second time window: operate in a second operation mode such that source STA operates in a multi-link operation mode using the primary link and one or more secondary links or that the source STA decreases the packet transmission rate from the source STA to the destination STA based on the congestion predication signal indicating the second operation mode.

In some embodiments, the processor is further configured to, during a third time window: return to operating in the first operation mode based on the congestion predication signal indicating the first operation mode.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 illustrates a system model in accordance with an embodiment.

FIG. 5 illustrates using timestamps for congestion control in accordance with an embodiment.

FIG. 6 illustrates a system for congestion prediction in accordance with an embodiment.

FIG. 7 illustrates a Kalman filter-based congestion prediction without Explicit Congestion Notification (ECN) in accordance with an embodiment.

FIG. 8 illustrates a state diagram of a dynamic switching for congestion control in accordance with an embodiment.

FIG. 9 illustrates a graph of a soft switching in accordance with an embodiment.

FIG. 10 illustrates a state diagram of a dynamic switching for congestion control using different sending rates in accordance with an embodiment.

FIG. 11 illustrates a graph of a soft switching only when single link operation (SLO) is available in accordance with an embodiment.

FIG. 12 illustrates a state diagram of a dynamic switching when multi-link operation (MLO) has more than two links in accordance with an embodiment.

FIG. 13 illustrates a Kalman filter-based congestion prediction with ECN in accordance with an embodiment.

FIG. 14 illustrates a procedure with early ECN marking in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

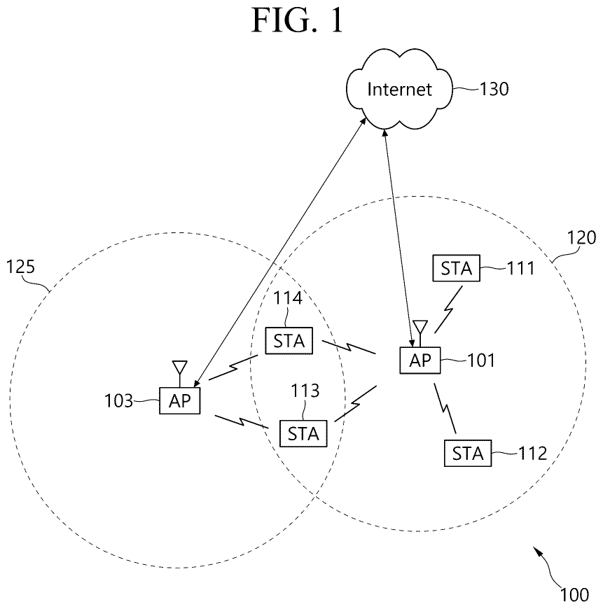

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

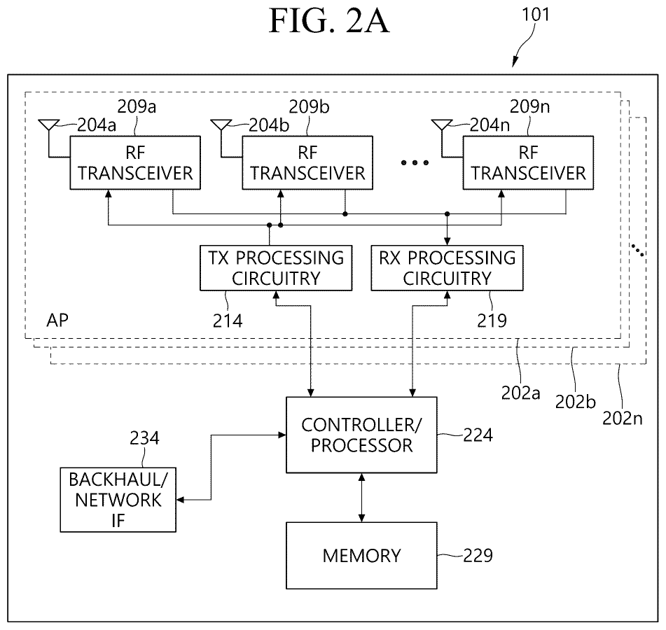

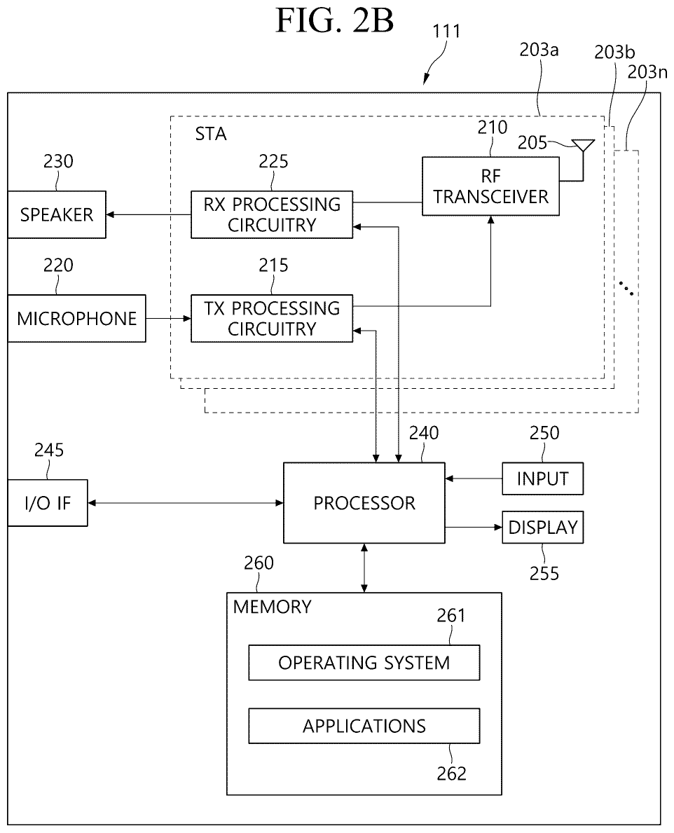

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

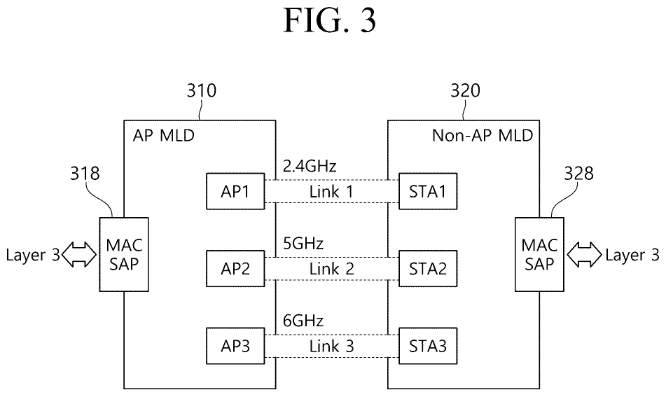

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

In some embodiments, congestion control (CC) may be used to manage network resources in an efficient manner to prevent network disruption and provide resource sharing across competing traffic flows. Accordingly, CC may minimize packet losses and thus improve a reliability of traffic streams. In some embodiments, delay-based CC approaches may be optimized for efficient use in high-speed networks, allowing for rapid integration into full link utilization without burdening the network.

The Transmission Control Protocol (TCP), which has been primarily focused on reliability, may not be adequate to handle real-time traffic flows, in part due to the utilization of retransmissions and acknowledgements within the TCP protocol. Although the User Datagram Protocol (UDP) may be more satisfactory to handle traffic real-time flows, CC mechanisms are not available with UDP. Accordingly, in some embodiments, for a real-time traffic flow, a CC mechanism may be integrated at the application layer. In some embodiments, a buffer in a bottleneck may be utilized to absorb a burst traffic when an input rate is greater than the output rate. However, when the sending rate is greater than the output rate persistently, a queue may build in the buffer. Furthermore, when the number of the waiting packets in the buffer begins to be greater than the buffer's maximum size, packets may be dropped. That is, packets may be enqueued until they are dropped.

In some embodiments, a size of the buffer and/or the link speed of the bottleneck can be dynamically changed (e.g., increased or decreased) to mitigate congestion. In some embodiments, a source of network traffic may reduce a network load by sending data more slowly to a destination. In some embodiments, CC can be designed by reserving in advance a fixed bandwidth in the network and/or adaptively allocating a bandwidth in response to a congestion indication signal fed back by a destination. In some embodiments, based on the available hardware resources, an open loop CC control may be preferable for dynamic real-time traffic handling.

In some embodiments, for a congestion indication signal, a destination can use an explicit congestion notification (ECN), where a device (e.g., router, switch, among others) may mark a packet based on a queue occupancy. For example, a router may mark a packet with an indication that a packet may encounter congestion along the way. Having received the ECN, the destination may notify the source about a congestion. For example, the buffer in the router is reaching a maximum storage capacity among other factors that may result in congestion. In some embodiments, implicit congestion indications, such as packet loss and packet delays among other factors, can be used to determine a state of congestion within a network. In particular, a round-trip time (RTT) of packet transmission may increase as packets are enqueued in a buffer, so that RTT can be correlated to the congestion. Accordingly, as an ECN may not always be available to determine congestion, the destination may need to use other features to determine a state of congestion and to provide feedback to the source.

In some embodiments, for an adaptive rate approximation of a single-link operation (SLO), the source may need to smooth traffic by reducing a sending rate when congestion is signaled. In some embodiments, multi-link operation (MLO) may use one or more secondary helper links in addition to a primary link, so that when congestion is signaled, the MLO-MAC can make a switch from SLO to MLO, rather than smooth traffic as the conventional SLO.

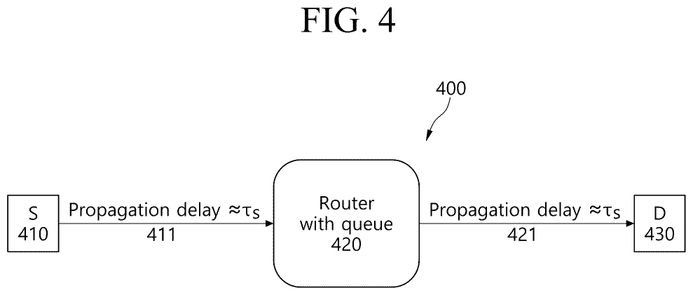

FIG. 4 illustrates a system for congestion prediction in accordance with an embodiment. In particular, FIG. 4 illustrates a system 400 that includes a source(S) 410 communicating with a router (R) 420 over a link 411. As illustrated, the router 420 includes a queue. The router 420 communicates with a destination (D) 430 over a link 421. As illustrated, the source(S) 410 may need to understand the congestion state over the links 411 and 421, which are connected with the router (R) 420, and the destination (D), 430. In some embodiments, the router (R) 420 may not mark a packet via an explicit congestion notification (ECN). In certain embodiments, the destination (D) 430 may not be able to access timestamps of the packets' transmissions recorded at the source(S), 410. Thus, it may be necessary to find an implicit feature at the destination (D) 430, to indicate the congestion state over the links 411 and 421, In some embodiments, the corresponding congestion indication or signal may be used by the MLO-MAC that resides in the source(S), 410 to make a dynamic switching between SLO and MLO to reduce congestion over the primary link of the SLO.

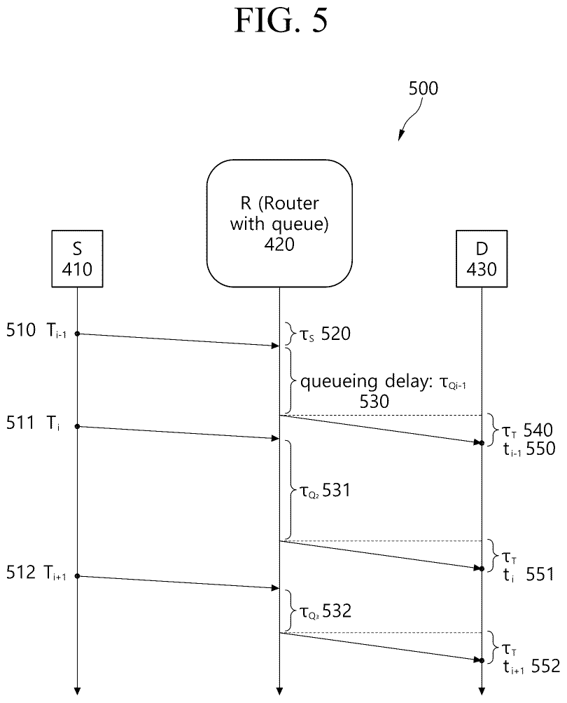

FIG. 5 illustrates utilizing timestamps for congestion control in accordance with an embodiment. In particular, FIG. 5 illustrates the timestamps recorded at the source(S) 410, router (R) 420, and destination (D) 430. The destination (D) 430 may be required to use available timestamps such as the packet arrival time such as tᵢ₋₁, 550, ty, 551, and tᵢ₊₁, 552, at the D, 430, without knowledge of the packet departure times such as Tᵢ₋₁, 510, Tᵢ, 511, and Tᵢ₊₁, 512, recorded at the source(S) 410. Furthermore, a target feature may need to be correlated with the queuing delays such as τ_{Q}_{_{i−1}}, 530, τ_{Q}_{₂}, 531, and τ_{Q}_{₂}, 532, experienced by the buffer or queue deployed at the router (R) 420, and propagation delays τₛ, 520 and τ_{T}, 540, respectively experienced over the link 411 and 421. Embodiments in accordance with this disclosure may, based on a target feature, predict a congestion and provide a corresponding indication or signal to the source(S) 410. In some embodiments, the MLO-MAC (e.g., source 410) can use the primary and one or more secondary links (e.g., helper links) dynamically to reduce the congestion over the primary link when more than one link is available. In some embodiments, the MLO-MAC (e.g., source 410) may change a sending rate adaptively when only the primary link is available.

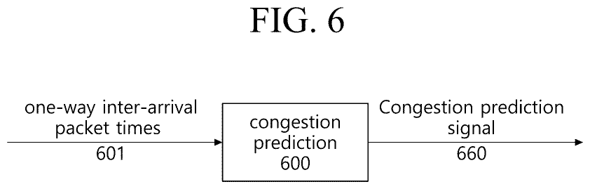

FIG. 6 illustrates a system for congestion prediction using an implicit feature in accordance with an embodiment. In particular, one-way inter-arrival packet times 601 can be input to congestion prediction 600 which can output a congestion prediction signal 660. In some embodiments the one-way packet arrival time may be used as the feature for the congestion prediction signal. In some embodiments, a delay-based CC approach may provide a low-latency data transfer by controlling network congestion as soon as bottlenecks begin to occur. In some embodiments, when the packet size is the same in the target stream, clocks may be quasi-synchronized among the source S, router R, and destination D. Furthermore, the propagation delays may be almost constant over the target stream under an assumption that a path re-routing will not occur during transmissions of the target stream. Referring back to FIG. 5, which illustrates three successive arrival timestamps, tᵢ₋₁, 550, tᵢ, 551 and tᵢ₊₁ 552 are respectively recorded as shown in Equations (1) to (3):

$${t}_{i - 1} = {T}_{i - 1} + {τ}_{S} + {τ}_{{Q}_{i - 1}} + {τ}_{T} \qquad ( 1 )$$

$${t}_{i} = {T}_{i} + {τ}_{S} + {τ}_{{Q}_{i}} + {τ}_{T} \qquad ( 2 )$$

$${t}_{i + 1} = {T}_{i + 1} + {τ}_{S} + {τ}_{{Q}_{i + 1}} + {τ}_{T} \qquad ( 3 )$$

With reference to FIG. 5 and FIG. 6, then, the one-way inter-arrival packet times, 601, measured between two successive packets, are respectively given by Equations (4) and (5):

$${Δ}_{i} = {t}_{i} - {t}_{i - 1} = {T}_{i} - {T}_{i - 1} + {τ}_{{Q}_{i}} - {τ}_{{Q}_{i - 1}} \qquad ( 4 )$$

$${Δ}_{i + 1} = {t}_{i + 1} - {t}_{i} = {T}_{i + 1} - {T}_{i} + {τ}_{{Q}_{i + 1}} - {τ}_{{Q}_{i}}$$

By calculating a difference between two successive one-way arrival packet times, common unknown propagation delays, τₛ 520 and τ_{T} 540, can be eliminated in the expression of the one-way inter-arrival packet times. Also, Equations (4) and (5) show that Δᵢ and Δᵢ₊₁ have relationships with the packet departure times, Tᵢ₋₁, Tᵢ, Tᵢ₊₁, respectively, 510, 511, and 512, and queueing delays, τ_{Q}_{_{i−1}}, τ_{Q}_{ᵢ}, τ_{Q}_{ᵢ₊₁}, respectively, 530, 531, and 532. According to Equations (4) and (5), we can further have as shown in Equation (6):

$${d}_{i} = \frac{1}{W} {\sum }_{j = i}^{i + W - 1} {Δ}_{j} = \frac{1}{W} ( {T}_{i + W - 1} - {T}_{i} ) + \frac{1}{W} ( {τ}_{{Q}_{i + W - 1}} - {τ}_{{Q}_{i}} ) \qquad ( 6 )$$

which is the mean of the sliding window composed by W successive one-way arrival packet times starting from Δᵢ. Equation (6) shows that by averaging over W successive one-way arrival packet times, dᵢ is expressed by two one-way arrival packet times; (i) the starting one-way arrival packet time Tᵢ; (ii) and the last one-way arrival packet time, T_{i+W-1}, in such a way that the difference between them is reduced by the sliding window size, W. Similarly, the queuing delay difference occurred at the router R 420, is also reduced by W. Thus, a smoothing filter may be applied to each of the sliding windows in the computation of dᵢ. In some embodiments, Kalman filters may be used to predict congestion state.

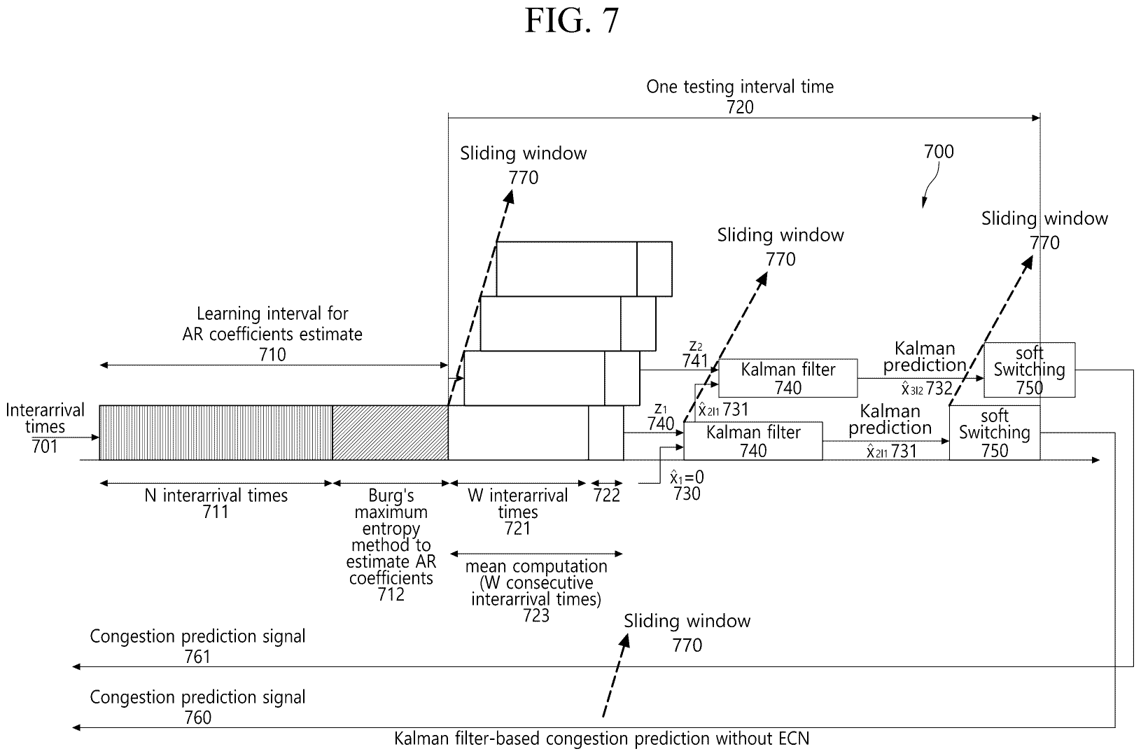

FIG. 7 illustrates a Kalman filter-based congestion prediction without ECN in accordance with an embodiment. In some embodiments, based on an available set of measurements dᵢs, a key problem to address may be to predict an upcoming congestion state. For this purpose, some embodiments in accordance with this disclosure may use a filter, for example, the 3^{rd} order Kalman filter, 740, whose dynamic and measurement equations are given by Equations (7) and (8):

$$[ \begin{matrix}{x}_{1 , i} \\ {x}_{2 , i} \\ {x}_{3 , i}\end{matrix} ] = [ \begin{matrix}{α}_{1} & {α}_{2} & {α}_{3} \\ 1 & 0 & 0 \\ 0 & 1 & 0\end{matrix} ] [ \begin{matrix}{x}_{1 , i - 1} \\ {x}_{2 , i - 1} \\ {x}_{3 , i - 1}\end{matrix} ] + [ \begin{matrix}1 & 0 & 0 \\ 0 & 1 & 0 \\ 0 & 0 & 1\end{matrix} ] [ \begin{matrix}{w}_{1} \\ {w}_{2} \\ {w}_{3}\end{matrix} ] \qquad ( 7 )$$

$${z}_{i} = [ \begin{matrix}1 & 0 & 0\end{matrix} ] [ \begin{matrix}{x}_{1 , i} \\ {x}_{2 , i} \\ {x}_{3 , i}\end{matrix} ] + R \qquad ( 8 )$$

where the Kalman filter's coefficients {α₁, α₂, α₃} determine the dynamic model to predict the sliding-window-wised congestion, 770. The Kalman filter's autoregressive (AR) coefficients {α₁, α₂, α₃} may be unknown and depend on the incoming traffic, and should be computed or trained beforehand. Some embodiments may estimate the AR coefficients from samples within a training interval. In some embodiments, Burg's maximum entropy-based methods may be employed for the estimation.

In some embodiments, {x_{1,k}, x_{2,k}, x_{3,k}}, denotes a set of states which describe a congestion that Kalman filter estimates. In addition, {w₁, w₂, w₃} represents a set of process noises that represents the uncertainties in the Kalman filter's state estimates and the degree of correlation between the errors existing among state estimates. In some embodiments, wᵢs are assumed to be independent and Gaussian with zero mean and Q variance. In some embodiments, zᵢ≡dᵢ, 740 and 741, is the measurement obtained from the ith sliding window with R representing a measurement noise. In some embodiments, due to the use of the sliding window, one dᵢ is lagging between two successive operation in the destination.

Burg's maximum entropy-based method in accordance with some embodiments is disclosed herein. Since it may not be easy to find a reliable dynamic model of congestion for heterogeneous traffic, that is, to find Kalman filter's dynamic coefficients {α₁, α₂, α₃}, some embodiments may apply Burg's maximum entropy-based method. For N sliding windows, 711, each of which is composed by W successive one-way inter-arrival packet times 701, Burg's maximum entropy-based method, 712, provides an estimate of {α₁, α₂, α₃}, that is, a dynamic equation for the sliding-window-wised congestion can be determined with a parameter Q.

In some embodiments, upon finishing the learning interval for the Kalman coefficients' computation interval, 710, a testing interval, 720, starts. That is, the Kalman filter is ready to be used for the prediction. One testing interval, 720, may be composed of i) an initial filling up interval to make an initial sliding window, 721, and operation, 722, to compute the mean of the sliding window 723, e.g., z₁, 740, and z₂, 741, sequentially; ii) the Kalman filter operates for an initial prediction, \hat{x}₁=0, 730, and the measurement, and generate the Kalman prediction, \hat{x}_{(2|1)}, 731 and \hat{x}_{(3|2)}, 732; and iii) the soft switching, 750, operates on the Kalman prediction with respect to two thresholds, Th₁ and Th₂, and then generates the congestion prediction signals, 760 and 761, for the first two sliding windows. These operations are performed for each of the sliding windows, 770.

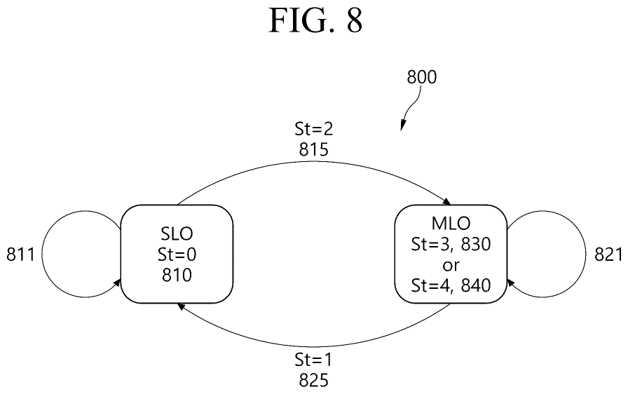

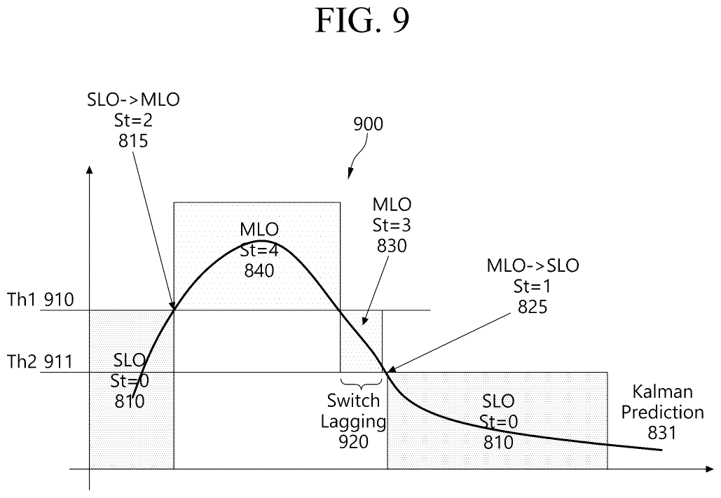

FIG. 8 illustrates a state diagram of a dynamic switching for congestion control in accordance with an embodiment. FIG. 9 illustrates a graph of a soft switching in accordance with an embodiment. Referring to FIG. 8 and FIG. 9, a state diagram of a dynamic switching for congestion control is specified by 800, in which the two key states, SLO and MLO determine the dynamic MLO-MAC switching operation from a single link operation (SLO) to using multi-link operation (MLO) with an available two links or more, e.g., the primary link and one or more secondary helper links. In particular, FIG. 8 illustrates switching between different states, including state zero (St=0) 810, state three (St=3) 830, and state four (St=4), 840, via various state transitions including (St=2) 815 that transitions from state zero (St=0) 810 to state four (St=4) 840, and state transition (St=1) 825 that transitions from state three (St=3) 830 back to state zero (St=0) 810.

In some embodiments, state zero (St=0) 810 corresponds to the MLO-MAC in the SLO with the primary link, which may be the default mode. When a destination (e.g., destination D 430) predicts that a congestion begins to occur on the primary link, the MLO-MAC transitions, via state transition 815, to state four 840 whereby the source (e.g., source S 410) may use one or more secondary helper links to reduce the bottleneck over the primary link. Accordingly, the MLO-MAC switches from state zero (St=0) 810 to the MLO state four (St=4), 840 via a state transition (St=2) 815.

Referring to the soft switching provided in FIGS. 9 and 900, and Kalman prediction, 831, the MLO-MAC switches from the state zero (St=0) 810 to MLO with state four (St=4), 840, when the Kalman prediction, 831 (i.e., \hat{x}_{(2|1)}) for the second sliding window, is greater than Th 910. For the kth sliding window, the MLO-MAC compares \hat{x}_{(k|k-1)} with Th₁ 910. If the Kalman prediction 831 is not greater than Th₁ 910, the MLO-MAC controls the source(S) to use only the primary link. In particular, the MLO-MAC keeps the SLO with state zero (St=0) 810, via state transition 811.

When the MLO-MAC is in the MLO with state four (St=4) 840, the MLO-MAC switches only back to the SLO state zero (St=0) 810, via a state transition (St=1) 825, when the Kalman prediction, 831 (i.e., \hat{x}_{(2|1)}) is smaller than Th₂ 911.

With the condition of Th₁>Th₂, an additional third state is added as MLO with state three (St=3), 830. By addition of the third state (St=3), 830, the MLO-MAC may keep control(S) to use both the primary and secondary helper links even after \hat{x}_{(2|1)} is smaller than Th₁ 910 while it is greater than Th₂ 911, via state transition 821. Accordingly, a lag in the switching, 920, may result with the additional third state (St=3) 830 to avoid rapid switches from MLO to SLO.

In some embodiments, a dynamic sending rate change of the SLO may be used for CC. In some embodiments, when only the SLO mode is available, that is, source(S) can access only the primary link, the dynamic switching algorithm makes the MLO-MAC change the sending rate of the source(S) in response to the congestion indication or signal.

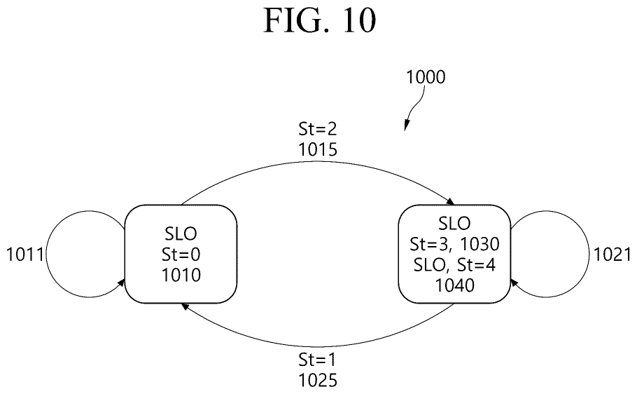

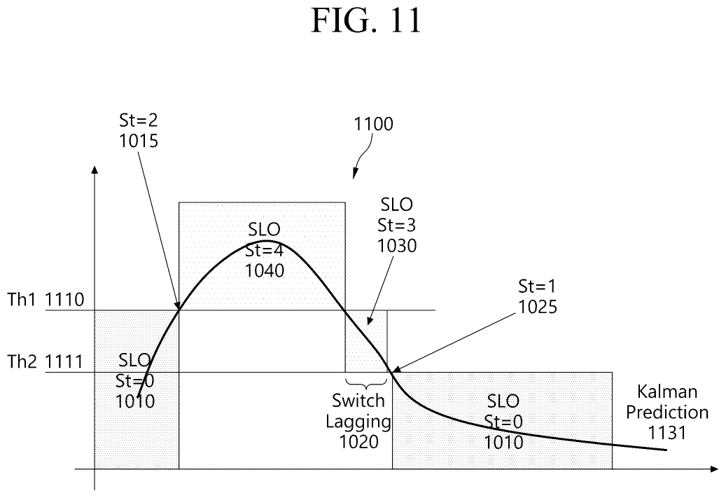

FIG. 10 illustrates a state diagram of a dynamic switching for congestion control using different sending rates. FIG. 11 illustrates a graph of a soft switching when only SLO is available in accordance with an embodiment. Referring to FIG. 10 and FIG. 11, a state diagram of the dynamic switching for the congestion control is specified by 1000, in which SLO with different sending rates determine the dynamic MLO-MAC switching operation, 1100. In particular, FIG. 10 illustrates switching between different states, including state zero (St=0) 1010, state three (St=3) 1030, and state four (St=4), 1040, via various state transitions including (St=2) 1015 that transitions from state zero (St=0) to state four (St=4), and state transition (St=1) 1025 that transitions from state three (St=3) back to state zero (St=0).

In the MLO-MAC, when the source(S) is in SLO with state zero (St=0), 1010, the MLO-MAC controls the source(S) to enter SLO with state four (St=4), 1040, via a state transition (St=2) 1015, when the Kalman prediction 1131 is greater than Th₁ 1110 to reduce the sending rate of S, that is shown by Equation (9):

$${R}_{k + 1} = α {R}_{k} , \qquad ( 9 )$$

$$with$$

$$α < 1$$

Even with SLO in either state four (St=4) 1040 or state three (ST=3) 1030, the MLO-MAC updates the sending rate of the source(S) according to Equation (9), via state transition 1021.

When the Kalman prediction 1131 is less than Th₂ 1111, the congestion state enters SLO with state zero (St=0) 1010, via a state transition (St=1) 1025. In state zero (St=0) 1010, the MLO-MAC keeps increasing the sending rate of the source(S) as shown in Equation (10):

$${R}_{k + 1} = {R}_{k} + β , \qquad ( 10 )$$

$$with$$

$$β > 0$$

over the interval that the Kalman predictions are smaller than Th₁ 1110 which is the state transition represented by 1011. Some embodiments may use a dynamic link adaptation for MLO.

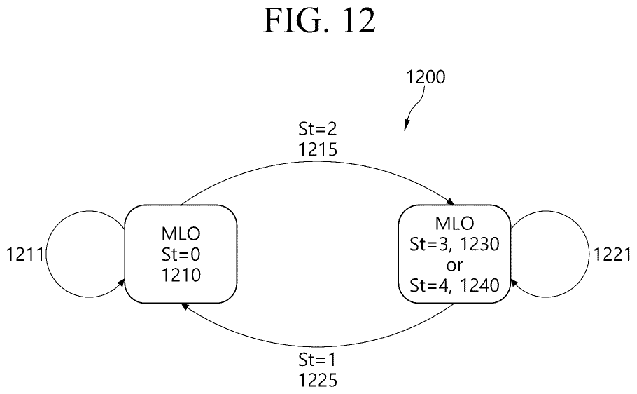

FIG. 12 illustrates a state diagram of a dynamic switching when MLO has more than two links in accordance with an embodiment. In some embodiments, for the MLO setup, where more than two links are available for MLO-MAC, 1200, a dynamic link adaptation for MLO is possible. In particular, FIG. 12 illustrates switching between different states, including state zero (St=0) 1210, state three (St=3) 1230, and state four (St=4), 1240, via various state transitions including (St=2) 1215 that transitions from state zero (St=0) to state four (St=4), and state transition (St=1) 1225 that transitions from state three (St=3) back to state zero (St=0).

As illustrated, MLO with state zero (ST=0) 1210, is the state where no additional links are necessary to avoid congestion among a set of deployed links. However, when a congestion starts to occur, a state transition (St=2) 1215, is performed to avoid congestion among a set of deployed links. Thus, the congestion state switches to MLO with state four (St=4) 1240, based on the Kalman prediction compared with TH₁. In this state four (St=4), an additional link may be used as a helper link. In some embodiments, depending on the comparisons with respect to Th₁ and Th₂, congestion states may be kept in either MLO with state four (St=4) 1240, represented by a state transition (St=1) 1221, or MLO with state three (St=3) 1230. However, either in state four (St=4) 1240 or state three (St=3) 1230, the congestion state switches to MLO with state zero (St=0) 1225 via a state transition (St=1) 1225, when the Kalman prediction is smaller than Th₂. In some embodiments, a dynamic SLO-MLO switching with input of ECN may be used for congestion control.

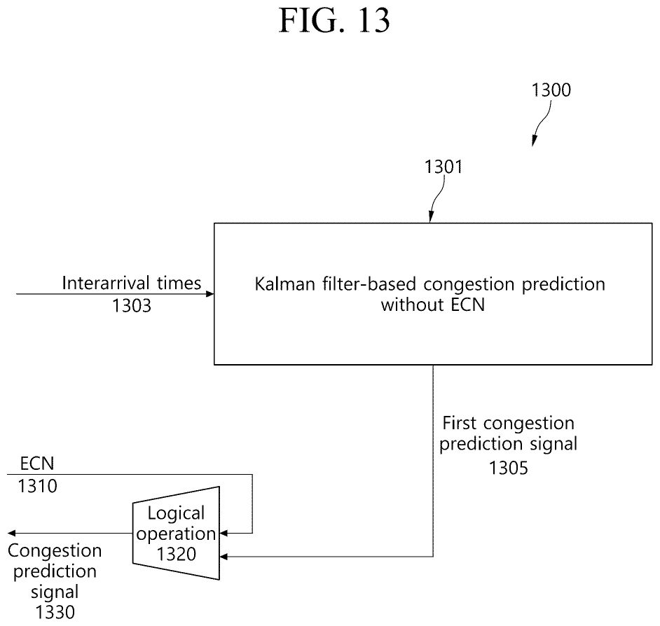

FIG. 13 illustrates a Kalman filter-based congestion prediction with ECN in accordance with an embodiment. As illustrated, interarrival times 1303 are provided to the Kalman filter-based congestion prediction without ECN 1301, which outputs a first congestion predication signal 1305. As illustrated, when ECN 1310 is provided by a router as the congestion notification, 1310, the dynamic SLO-MLO switching, 1300, may use the congestion prediction signal 1310, the output of the Kalman filter-based congestion prediction 1305, as an additional indication signal to output the final congestion prediction signal, 1330. A logical operation (logical “and” or logical “or”) may be performed in the block 1320. In some embodiments, for a more restrictive congestion prediction signal, a logical “and” may be performed over two distinctive congestion intervals determined by 1310 and 1320. In some embodiments, to cover more congestion time intervals a logical “or” operation can be performed.

In some embodiments, an adaptive changing of earning interval for AR coefficients estimate may be used for CC. Depending on an application's profile, the learning interval for the estimate of AR coefficients (e.g., learning interval for AR coefficients estimate 710 in FIG. 7) can be adaptable. In some embodiments, early ECN marking for adjustment based on congestion detected at the destination may be used for CC.

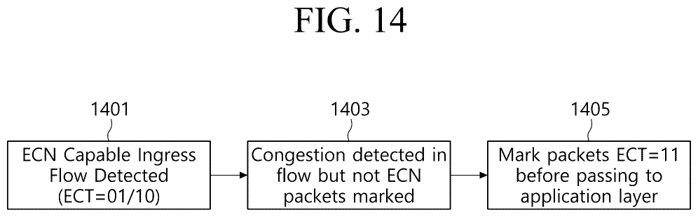

FIG. 14 illustrates a procedure with early ECN marking in accordance with an embodiment. Although one or more operations are described or shown in particular sequential order, in other embodiments the operations may be rearranged in a different order, which may include performance of multiple operations in at least partially overlapping time periods.

In operation 1401, the congestion predictor may be assigned to a traffic flow that has ECN enabled (e.g., ECT bits in IP header set to 01, 10).

In operation 1403, if the congestion predictor detects congestion in the flow but the ECN bits have not been marked yet (e.g., due to the queue having looser limits on queue delay), the congestion predictor may then classify, in operation 1405, the packets before forwarding to the application.

Embodiments in accordance with this disclosure may provide congestion control (CC) to manage network resources in an efficient manner to prevent network disruption and provide resource sharing across competing flows, which may prevent packet losses and thus improve communication on wireless networks.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A destination station (STA) in a wireless network, comprising:
a memory; and
a processor coupled to the memory, the processor configured to:
receive, from a source STA via a router, a plurality of packets, the router being located between the destination STA and a source STA;
determine a congestion prediction to the source STA based on packet arrival times of the plurality of packets;
compare the congestion prediction with a first threshold;
generate a congestion prediction signal based on the comparison, wherein the congestion prediction signal indicates an operation mode of the source STA; and
transmit, to the source STA via the router, the congestion prediction signal.

2. The destination STA of claim 1, wherein the packet arrival times are associated with delay in a buffer at the router or propagation delay between the destination STA and the source STA.

3. The destination STA of claim 1, wherein the processor is further configured to, during a first time window:
determine that the congestion prediction is less than the first threshold; and
generate the congestion prediction signal indicating a first operation mode that the source STA operates in a single link operation mode using a primary link or that the source STA maintains a packet transmission rate from source STA to the destination STA.

4. The destination STA of claim 3, wherein the processor is further configured to, during a second time window:
determine that the congestion prediction is greater than the first threshold; and
generate the congestion prediction signal indicating a second operation mode that the source STA operates in a multi-link operation mode using the primary link and one or more secondary links or that the source STA decreases the packet transmission rate from the source STA to the destination STA.

5. The destination STA of claim 4, wherein the processor is further configured to, during a third time window:
determine that the congestion prediction is less than a second threshold, wherein the second threshold is less than the first threshold; and
generate the congestion predication signal indicating that the source STA returns to operating in the first operation mode.

6. The destination STA of claim 1, wherein the processor is further configured to estimate a set of autoregressive coefficients that models congestion from the packet arrival packet times.

7. The destination STA of claim 6, wherein the processor is further configured to perform training on samples within a training interval to estimate the set of autoregressive coefficients.

8. The destination STA of claim 1, wherein the processor is further configured:
receive, from the router, a congestion notification signal indicating congestion at the router; and
perform a logical operation based on the received congestion notification signal and the congestion prediction signal to generate the congestion prediction signal.

9. A source station (STA) in a wireless network, comprising:
a memory; and
a processor coupled to the memory, the processor configured to:
receive, from a destination STA via a router, a congestion predication signal that indicates an operation mode for the source STA, the router being located between the source STA and the destination STA; and
transmit packets to the destination STA based on the operation mode indicated by the congestion predication signal.

10. The source STA of claim 9, wherein the processor is further configured to, during a first time window:
operate in a first operation mode such that the source STA operates in a single link operation mode using a primary link or that the source STA maintains a packet transmission rate from source STA to the destination STA based on the congestion prediction signal indicating the first operation mode.

11. The source STA of claim 10, wherein the processor is further configured to, during a second time window:
operate in a second operation mode such that source STA operates in a multi-link operation mode using the primary link and one or more secondary links or that the source STA decreases the packet transmission rate from the source STA to the destination STA based on the congestion predication signal indicating the second operation mode.

12. The source STA of claim 11, wherein the processor is further configured to, during a third time window:
return to operating in the first operation mode based on the congestion predication signal indicating the first operation mode.

13. A computer-implemented method for wireless communication by a destination station (STA) in a wireless network, comprising:
receiving, from a source STA via a router, a plurality of packets, the router being located between the destination STA and a source STA;
determining a congestion prediction to the source STA based on packet arrival times of the plurality of packets;
comparing the congestion prediction with a first threshold;
generating a congestion prediction signal based on the comparison, wherein the congestion prediction signal indicates an operation mode of the source STA; and
transmitting, to the source STA via the router, the congestion prediction signal.

14. The computer implemented method of claim 13, wherein the packet arrival times are associated with delay in a buffer at the router or propagation delay between the destination STA and the source STA.

15. The computer implemented method of claim 13, further comprising, during a first time window:
determining that the congestion prediction is less than the first threshold; and
generating the congestion prediction signal indicating a first operation mode that the source STA operates in a single link operation mode using a primary link or that the source STA maintains a packet transmission rate from source STA to the destination STA.

16. The computer implemented method of claim 15, further comprising, during a second time window:
determining that the congestion prediction is greater than the first threshold; and
generating the congestion prediction signal indicating a second operation mode that the source STA operates in a multi-link operation mode using the primary link and one or more secondary links or that the source STA decreases the packet transmission rate from the source STA to the destination STA.

17. The computer implemented method of claim 16, further comprising, during a third time window:
determining that the congestion prediction is less than a second threshold, wherein the second threshold is less than the first threshold; and
generating the congestion predication signal indicating that the source STA returns to operating in the first operation mode.

18. The computer implemented method of claim 13, further comprising estimating a set of autoregressive coefficients that models congestion from the packet arrival packet times.

19. The computer implemented method of claim 18, further comprising performing training on samples within a training interval to estimate the set of autoregressive coefficients.

20. The computer implemented method of claim 13, further comprising:
receiving, from the router, a congestion notification signal indicating congestion at the router; and
performing a logical operation based on the received congestion notification signal and the congestion prediction signal to generate the congestion prediction signal.
